(19) United States
(12) Patent Application Publication
(10) Pub. No.: US 2011/0091284 A1
(43) Pub. Date: Apr. 21, 2011

(54) Rigid Hull Gas-Can Buoys Variable Buoyancy

(75) Inventor: Charles R. Yemington, Arlington, TX (US)

(73) Assignee: MY TECHNOLOGIES, L.L.C., Houston, TX (US)

(21) Appl. No.: 12/878,188

(22) Filed: Sep. 9, 2010

Related U.S. Application Data
(63) Continuation-in-part of application No. 12/714,919, filed on Mar. 1, 2010.
(60) Provisional application No. 61/252,819, filed on Oct. 19, 2009.

(51) Int. Cl. F16L 1/20; B63B 22/00; B63B 39/00

(52) U.S. Cl. 405/171; 441/1; 114/121

(57) ABSTRACT

The present invention is an apparatus and method directed to a variable buoyancy gas-can buoyancy module or buoy having a flexible barrier between a variable volume gas chamber in the gas-can hull and water in the hull. More specifically, the present invention is directed to a variable buoyancy module for a Self Supporting Riser (SSR) wherein the tension in the SSR may be increased/decreased by increasing/decreasing the variable volume of a chamber formed by a flexible liner that provides a barrier between the variable volume gas chamber in the gas-can hull and water.

### CROSS-REFERENCE TO RELATED APPLICATION

This application is a Continuation-in-part of U.S. application Ser. No. 12/714,919, filed Mar. 1, 2010, entitled “Riser Technology”, and further claims benefit to U.S. Provisional Application Ser. No. 61/252,819, filed Oct. 19, 2009, entitled “Adjustable Volume Deep Submergence Buoyancy Module For Extended Deep Ocean Applications”, both of which are incorporated by reference.

### STATEMENT REGARDING FEDERALLY SPONSORED RESEARCH OR DEVELOPMENT

Not Applicable.

### FIELD OF INVENTION

The present invention is directed to a variable buoyancy gas-can module for use with a Self Supporting Riser (SSR). Further, the present invention is directed to the construction of a gas-can buoy, specifically to a flexible liner that is a barrier to isolate the gas from the water in the gas-can buoy especially at significant depths.

### BACKGROUND OF THE INVENTION

It has been the practice to use gas-can buoys for near surface buoys; however, when used at greater and greater depths in seawater the efficiency of the prior art buoys decreases. This is particularly true when the buoy must be partially ballasted to change the buoyancy. Seawater dissolves gas. Near surface seawater water tends to be saturated with gas due to its contact with the atmosphere where surface water is mixed by wave action. Below the wave zone there is little opportunity for water to have direct contact with the atmosphere so the water is essentially isolated from any potential source of additional gas. Further, as expressed by Henry's law, water under higher pressure must dissolve more gas to reach equilibrium so the quantity of gas needed for saturation increases with increasing depth in the ocean. Water deep in the ocean is typically water that has sunk from the surface due to density difference. Water that is saturated with gas near the surface and then sinks to greater depth is exposed to higher pressure without the opportunity to dissolve more gas. Water deep in the ocean therefore typically has far less gas dissolved than needed for saturation and therefore quickly dissolves gas that is exposed to it. Gas charged variable buoyancy for use below the near surface mixing zone, and particularly at greater depth, therefore requires an impermeable or very low permeability liner barrier between ambient water and the gas in order to avoid loss of gas (loss of buoyancy) that would result from contact between the gas and ambient water.

An object of the present invention is to provide an apparatus and method whereby gas/water isolation and variable buoyancy can be achieved without the need for precision machined sealing surfaces while maintaining the advantages of rigid hull gas-can buoyancy modules. A further object of the present invention is to provide a buoyancy module for a Self Supporting Riser (SSR) as fully described in U.S. application Ser. No. 12/714,919, filed Mar. 1, 2010, entitled “Riser Technology”. The large dimensions of the buoyancy module(s) of a deepwater SSR make it impractical to provide the precision machined surfaces required for conventional sliding seals between the hull and a barrier. Further the hull of a gas-can buoy for an SSR is subject to flexure due to load variations from current and other forces so the distance between the hull walls changes. An impermeable boundary or barrier between the gas and water is required. Still further, variable buoyancy is desired and therefore, this boundary or barrier must be movable in the hull to allow increase or decrease of gas volume and of buoyancy (the greater the gas volume—the greater the water displaced from the gas-can—the greater the buoyancy).

### SUMMARY OF THE INVENTION

The present invention is an apparatus and method directed to a variable buoyancy gas-can buoyancy module or buoy having a flexible barrier between a variable volume gas chamber in the gas-can hull and water in the hull. More specifically, the present invention is directed to a variable buoyancy module for a Self Supporting Riser (SSR) wherein the tension in the SSR may be increased/decreased by increasing/decreasing the variable volume of a chamber formed by a flexible liner that provides a barrier between the variable volume gas chamber in the gas-can hull and water.

### BRIEF DESCRIPTION OF THE DRAWINGS

FIG. 1 is a schematic view of one embodiment of a variable buoyancy rigid hull gas-can buoyancy module or buoy of the present invention;

FIG. 2 is a schematic view of another embodiment of a variable buoyancy rigid hull gas-can buoyancy module or buoy of the present invention;

FIG. 3 is a schematic view of a variable buoyancy rigid hull gas-can buoyancy module or buoy of the present invention with a fill/vent structure for increasing/decreasing the volume of a variable volume gas chamber from either the bottom or the top of the hull and with typical control elements;

FIGS. 4 and 5 are schematic views to illustrate a multi-chamber variable buoyancy rigid hull gas-can buoyancy module or buoy of the present invention; and

FIG. 4A is a schematic view of the multi-chamber variable buoyancy rigid hull gas-can buoyancy module or buoy of FIG. 4, illustrating that the center column in each of the chambers may be the structure for holding the flexible liner.

### DESCRIPTION OF THE EMBODIMENTS OF THE INVENTION

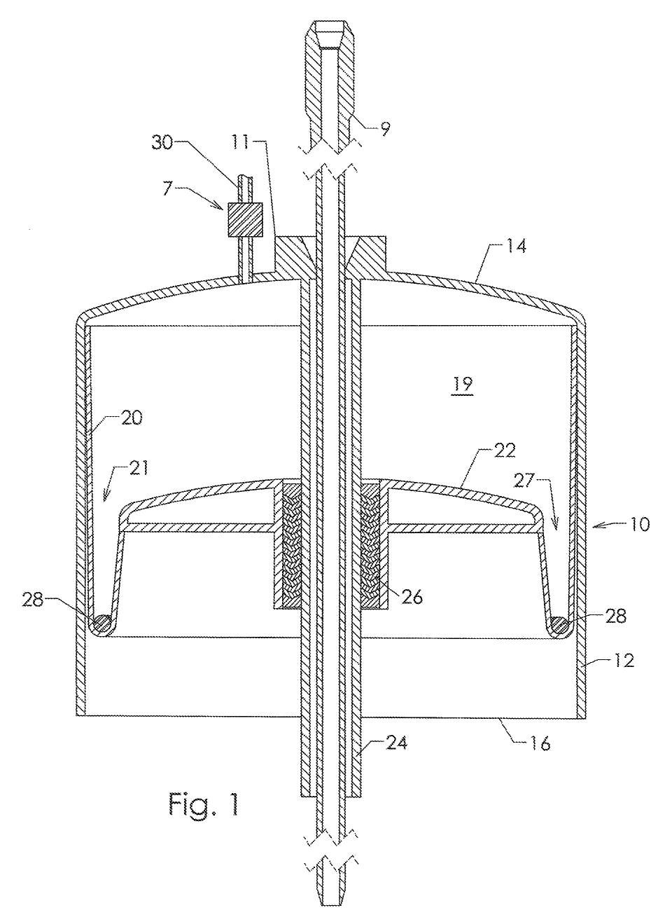

Referring to FIG. 1, a rigid gas-can hull 10 is preferably a cylindrical can with a cylindrical side surface 12 and a top surface 14. Hull 10 has a bottom 16 with vent openings, a screen (not shown) or an open lower end 16. In this embodiment a flexible cylindrical hull liner 20, the height of which is approximately equal to the height of the hull side surface or wall 12, is attached to the hull 10 near the top of side surface 12 or the top surface 14 and attached to an inner structure, a floating barrier 22 to bridge a clearance gap 21 (the distance between the side surface 12 of hull 10 and the floating structure 22) and provide a barrier between a variable volume gas chamber 19 in the gas-can hull and water, seawater that enters through lower end 16 in the hull.

The liner 20 is made of a flexible material that is highly impermeable to gas and water, such as metalized Mylar, a product of TEKRIA Corporation, or polyethylene film. The inner structure or floating structure 22 of this embodiment may be made from materials such as syntactic foam and epoxy bonded fiber glass to float on the water in or below hull 10. The inner structure 22 is free to move up and down inside the hull 10, and is kept aligned by either guides, which may be on a central column 24, or by the sliding sealed sleeve 26 around a central column 24. The relatively small dimensions of a central column 24 make it practical to maintain a conventional sliding seal between the floating structure 22 and the column 24. When the floating structure 22 is high on the column 24 there is slack in the liner 20. This slack is stored in a slack loop 27 (shown in FIG. 1 as a U-shape between ends of the liner 20 connected to the top of hull 10 and the outer end of structure 22) which is tended or maintained by weight such as sand or metal balls 28 to keep the slack or slack loop 27 in a known location. The loop 27 and weights 28 help ensure that the liner 20 is applied evenly to the wall 12 of the hull as the floating structure 22 goes down the column 24. If the liner were applied to the wall with wrinkles, the slack might all be used before the floating barrier reached the bottom of the hull. The upper surface of the floating structure 22 is sloped to help ensure that sand or balls 28 displaced onto the floating structure fall back down into the slack loop 27 of the liner 20. The specific structure of this embodiment is to deal with a phenomenon that must be dealt with in a high ambient pressure environment, i.e. the increase in friction between non lubricated surfaces. An analogy is a toy suction cup providing an example of ambient pressure holding a flexible surface tight against another surface. The friction force that must be overcome to slide the suction cup can be calculated as the coefficient of friction times the force holding the two surfaces together, which is ambient pressure times the surface area. With one atmosphere ambient pressure the friction force between a toy suction cup and the surface to which it is attached can be readily overcome. At a depth of just over 300 feet in the ocean, ambient pressure is approximately 10 times as much so the friction force is 10 times as great. With increasing depth, particularly over a large surface area, this friction force soon exceeds either the force available to slide the cup or flexible material or the strength of the flexible material. Free gas or liquid between the two surfaces minimizes or eliminates this friction force, as can be demonstrated by sliding the toy suction cup over a crack that provides access for ambient air to get between the suction cup and the surface to which it was engaged.

Preferably the liner 20 is a composite material that includes a layer of felt or open weave material attached to one or both sides of the gas and water impermeable layer of the liner so that free water is always permitted or wicked into the pores of the open weave material in a manner that maintains continuity of fluid to the ambient seawater. This helps ensure that when gas is introduced into the liner 20, as through line 30 in the top surface 14 (that includes a control box 7), the floating structure 22 moves down the column 24 or when gas is removed or vented from the liner 20, the structure 22 moves up the column 24 while the relatively impermeable barrier is maintained. These features provide a method and apparatus whereby variable buoyancy gas-cans have a rigid hull for protection and a liner between the water and the gas, and the volume of the enclosed gas chamber 19 can be changed in a way that does not require precision sealing surfaces, avoids sticking when sliding one material surface on another in the presence of high ambient pressure, and can include a method to reduce the friction so that the liner material can be held on the side surface 12 or removed without damage.

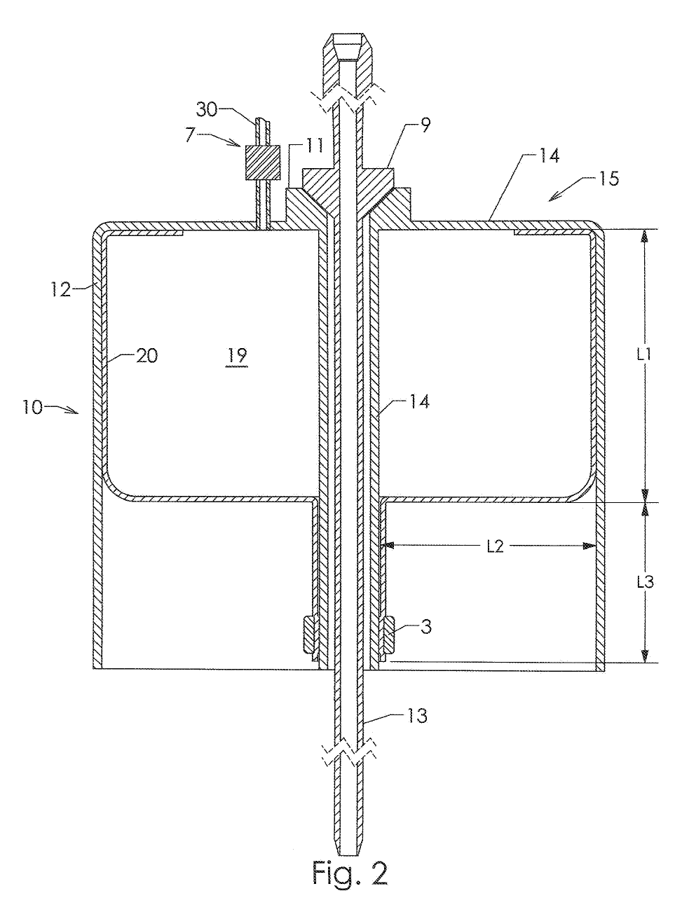

Now referring to FIG. 2, in this embodiment the phenomenon of high ambient pressure environment and the resulting increase in friction between non lubricated surfaces is addressed without need for the floating barrier 22. In this embodiment the liner 20 is removed from the side surface 12 of the hull 20 by moving it at a right angle from the surface. An analogy is removing tape from a surface. The tape will easily overcome the friction and adhesion without damage to the tape if pulled at a right angle to the surface. The flexible cylindrical hull liner 20, which provides a moveable barrier between air and water, is attached to the hull 10 near the top of side surface 12 or to the top surface 14 and attached to an inner structure, in this embodiment a central column 24, as by a ring 3. Flexible liner 20 provides a gas/water barrier between central column 24 and the hull side surface or wall 12 for any volume of variable volume gas chamber 19 in the gas-can hull. The volume of gas chamber 19 is increased by adding gas to the chamber 19 and the result is added buoyancy. The length of liner 20 is the sum of three dimensions; L1 the length held to wall 12; L2 the length that is in the gap between the wall 12 and column 24; and L3 the length held to column 24. It is noted that L2 remains constant and essentially horizontal to maintain the liner 20 at right angles to both the wall 12 and the column 24. When gas is introduced in line 30, the barrier across L2 is moved downward stripping a length of liner from the column 24, the increase of L1 being equal to the decrease in length of L3. That the liner 20 is stripped from column 20 at a right angle allows the liner to move without ripping or damage. Likewise, the volume of chamber 19 may be reduced by venting gas from line 30. The barrier across L2 as it moves upward strips a length of liner from wall 12, the decrease of L1 being equal to the increase in length of L3.

In a preferred embodiment, a joint 13 extends through central column 24 to produce a buoyancy module 15 for a Self Supporting Riser (SSR) as fully described in U.S. application Ser. No. 12/714,919, referred to above. The joint 13 illustrated is a conventional box and pin joint that has a shoulder 9 that fits to corresponding fitting 11 on the top surface 14 of can 10. However, load shoulder 9 may be the bottom of the box as illustrated in FIG. 1 or if the joint has flanges to connect the joints, the flanges may provide the load shoulder 9 for the variable buoyancy module 10. The SSR when in use is attached to seafloor structure such that when the buoyancy is varied or adjusted there is a corresponding change in lift or tension in the SSR. The SSR is made up of joints and specialty joints, such as the buoyancy module 15, as described more fully in U.S. application Ser. No. 12/714,919.

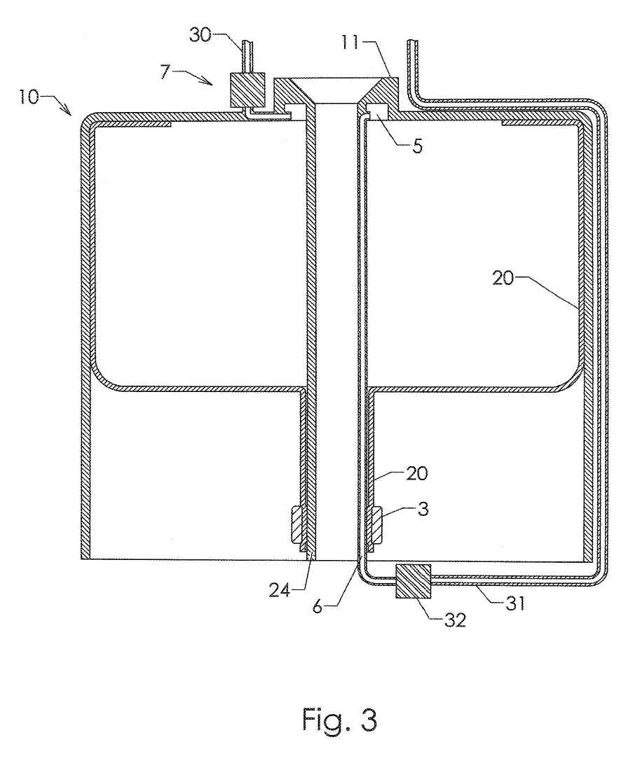

Referring to FIG. 3, another embodiment of a gas-can hull 10 has the gas added by a line 31 from the bottom of hull 10. In line 31 is a control element 32 that may include a valve and electronics to regulate the flow and/or to prevent overfill or under-fill so that the buoyancy can be varied safely in service. Line 31 has a vertical portion 6 that may be in the column 24, as shown, or in a groove in the side of column 24. The vertical portion 6 ends in a space 5 at or near the highest point in the chamber 19. Alternately a vent line 30 at the top of hull 10 may also terminate in space 5. A control element 7 allows filling and venting in a controlled manner to regulate the flow and/or to prevent overfill or under-fill so that the buoyancy can be varied safely in service.

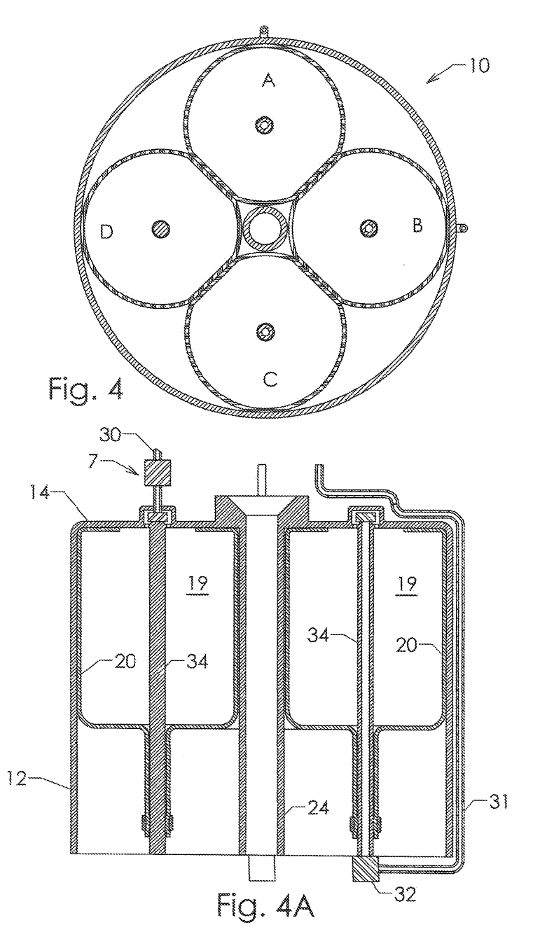

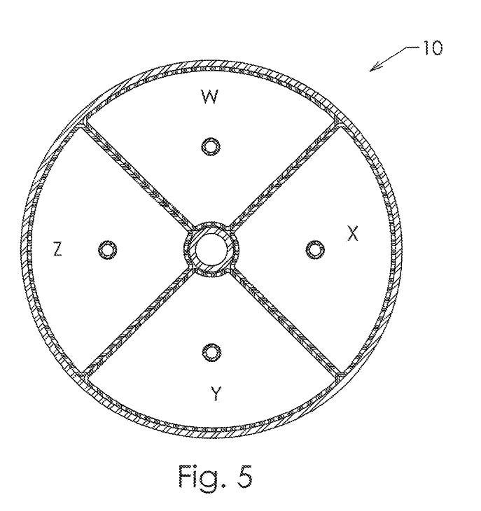

Referring now to FIGS. 4 and 5, configurations of multiple chamber rigid gas-can hulls 10 is illustrated. In FIG. 4, illustrated are four cylindrical chambers A-D in the hull 10, each of which may have details of structure as illustrated in the embodiments above. FIG. 5 illustrates that the cylindrical hull 10 may have four quadrants W-Z. The advantage of multiple chambers is redundancy.

Referring to FIG. 4A, each flexible cylindrical hull liner 20, the height of which is approximately equal to the height of the hull side surface or wall 12, is attached to the hull 10 near the top of side surface 12 or the top surface 14 and attached to an inner structure, in this embodiment a center column 34, to provide a barrier between a variable volume gas chamber 19 in the gas-can hull and water.

The volume of gas chamber 19 is increased by adding gas to the chamber 19 and the result is added buoyancy. Gas line 31 may enter the top of the hull as shown at the left of FIG. 4A or at the bottom of hull 10 as shown at the right of FIG. 4A.

1. A gas-can buoy for a Self Supporting Riser comprising:
a rigid hull; said hull including a top and side surface; and
a flexible, highly impermeable liner that provides a barrier in the gap between said side surface and an inner structure to form a variable volume gas chamber within said hull.

2. A gas-can buoy according to claim 1 wherein said inner structure is a floating structure.

3. A gas-can buoy according to claim 1 wherein said inner structure is a column.

4. A gas-can buoy according to claim 1 wherein said liner is a composite material having a permeable layer laminated to at least one side of the impermeable liner layer.

5. A gas-can buoy comprising:
a rigid hull; said hull including a top and side surface;
a central column extending axially within said hull; and
a load bearing surface at the top of said column shaped to transfer force to a riser joint in said column.

6. A gas-can buoy according to claim 5 which further includes:
a flexible, highly impermeable liner that provides a barrier in the gap between said side surface and said central column to form a variable volume gas chamber within said hull.

7. A rigid gas-can buoy according to claim 6 wherein said liner is attached at the top of said hull and the bottom of said central column.

8. A rigid gas-can buoy according to claim 5 wherein said central column is hollow and further includes:
a riser joint in said central column.

9. A rigid gas-can buoy according to claim 8 wherein said riser joint is a box and pin riser joint.

10. A multi-chambered rigid gas-can buoy comprising:
a rigid hull; said hull including a top and side surface;
inner structure within said hull to form multi-chambers; and
a movable flexible liner extending between said side surface and said inner structure to provide a variable volume gas chamber within each chamber of said hull.

11. A method for increasing/decreasing the buoyancy in a gas-can buoy having a flexible liner that provides a barrier in the gap between said side surface and an inner structure to form a variable volume gas chamber within said hull comprising:
adding/venting gas to said chamber whereby a greater/lesser length of said liner is held to said side surface and the volume of said gas chamber is increased/decreased.

12. A method according to claim 11 wherein the buoyancy is increased in a gas-can buoy having a flexible liner that provides a barrier in the gap between said side surface and an inner structure to form a variable volume gas chamber within said hull comprising:
adding gas to said chamber whereby a greater length of said liner is held to said side surface and the volume of said gas chamber is increased.

13. A method for increasing/decreasing the load on a riser joint in a Self Supporting Riser (SSR) comprising:
adding/venting gas to a variable volume gas chamber within the hull of a gas-can buoy that has said joint within a central column extending axially within said hull.

14. A method for increasing/decreasing the load on a riser joint in a Self Supporting Riser (SSR) wherein said joint is a box and pin riser joint.
